(19) United States
(12) Patent Application Publication
(10) Pub. No.: US 2005/0047516 A1
(43) Pub. Date: Mar. 3, 2005

(54) A method for dense and secure transmission of signals and information using a small number of channels

(76) Inventor: Vince I. Grolmusz, Budapest (HU)

Correspondence Address: VINCE GROLMUSZ, UGRON GABOR U.8., BUDAPEST, 1118, HU

(21) Appl. No.: 10/710,519

(22) Filed: Jul. 17, 2004

Related U.S. Application Data
(60) Provisional application No. 60/500,145, filed on Sep. 1, 2003.

(51) Int. Cl. H04L 1/02

(52) U.S. Cl. 375/267

(57) ABSTRACT

Suppose that there are n Senders and r Receivers. Our goal is to design a communication network such that long messages can be sent from Sender i to Receiver p(i) such that no other receiver can retrieve the message intended for Receiver p(i). The task can easily be completed using some classical interconnection network and routers in the network. Alternatively, if every Receiver is directly connected to all n Senders, then the Senders can choose which channel to use for communication, without using any routers. Fast optical networks are slowed down considerably if routers are inserted in their nodes. Moreover, handling queues or buffers at the routers is extremely hard in all-optical setting. An obvious routerless solution, connecting each possible Sender-Receiver pairs with direct channels seems to be infeasible in most cases. A method, solving this problem, is disclosed in which the Senders and the Receivers are connected with only a small number of channels (in practice no more than 32 channels); there are no switching or routing-elements in the network, just linear combinations of the signals are computed. Such designs are usable in fast all-optical networks. The security of the network does not depend on any unproven cryptographical or complexity theoretical assumptions.

### CROSS REFERENCE TO RELATED APPLICATIONS

This application claims priority from U.S. provisional patent application Ser. No. 60/500,145 filed Sep. 1, 2003.

### BACKGROUND OF INVENTION

The extreme bandwidth of a single optical fiber (25 000 GHz) is 1000 times larger than the total radio bandwidth of planet Earth (25 Ghz). Using this bandwidth effectively requires novel network designs.

Suppose that there are given n Senders S₁,S₂, . . . ,Sₙ and r Receivers R₁, R₂, . . . , Rᵣ. Let p be a function from {1,2, . . . , n} to {1,2, . . . ,r}. Our goal is to send long messages from Sᵢ to Rₚ₍ᵢ₎, for i=1,2, . . . , n such that
Rₚ₍ᵢ₎ can easily retrieve the message of Sᵢ for i=1,2, . . . , n, and
Rₚ₍ᵢ₎ cannot retrieve the message of Sⱼ if p(i) is not equal to p(j).

An obvious method for doing this is connecting Sᵢ with Rₚ₍ᵢ₎ with private channels, that is, we use n channels for the n Senders and the r Receivers. The advantage of this solution is that n bits can be sent in parallel, and the transmission is private, in the sense that Rₚ₍ᵢ₎ receives only the transmission of Sᵢ, for i=1,2, . . . , n. The privacy is satisfied only if others have not access to the private channels. The disadvantage of this solution is that the number of channels is equal to the number of communicating pairs, and this is infeasible in most cases.

Another problem with this solution is that if next time Sᵢ wants to send messages to Rₛ₍ᵢ₎, for i=1,2, . . . , n for some other function s, then the whole network has to be reconfigured. If every Sender is directly connected to all Receivers, this solves the reconfiguration problem, but then the number of channels becomes nr. Applying some classical interconnection networks (e.g., the butterfly, Benes network, CCC) needs routers with buffers (local memory).

Due to the table-lookup features of routers and the need of optical memory, all-optical routers are hard to construct, expensive and still relatively slow components.

Another obvious solution is that all the Senders and Receivers use the same channel, and they transmit their messages one after the other. Transmitting n bits this way needs n steps. In this case either a router has to be used just before the messages get to the Receivers, or some sort of encryption is needed for maintaining the privacy of the transmission.

Using encryption has several drawbacks. Streamciphers, the most evident cryptographic tool which are fast and do not cause overhead in the communication have lots of recently proposed and successful attacks. Block-ciphers are much slower, and may be infeasible in, say, in the 1000 Gbit/s range, and also, they causes non-negligible overhead in the communication.

Using routers and addressing in the messages will also slow down the communication, especially in all-optical environments: with, say, 1000 Gbit/s throughput, by the best of our knowledge, no routers exist.

References
Y. Azar, E. Cohen, A. Fiat, H. Kaplan, and H. Racke: Optimal oblivious routing in polynomial time. In Proceedings of the thirty-fifth ACM symposium on Theory of computing, pages 383-388. ACM Press, 2003.
S. Chatterjee and S. Pawlowski: All optical networks, Communications of the ACM, 42(6):74-83, 1999
C. Dovrolis, D. Stiliadis, and P. Ramanathan: Proportional differentiated services: Delay differentiation and packet scheduling. In SIGCOMM, pages 109-120, 1999
V. Grolmusz: Computing elementary symmetric polynomials with a sub-polynomial number of multiplications. SIAM Journal on Computing, 32(6):1475-1487, 2003
K. Hall and K. A. Rauschenbach: All-optical bit pattern generation and matching. Electron. Lett. 32:1214, 1996
P. Hawkes and G. Rose. Rewriting variables: the complexity of fast algebraic attacks on stream ciphers. Technical report, eprint.iacr.org/2004/081/, 2004
M. Jinno and T. Matsumoto: Nonlinear Sagnac interferometer switch and its applications, IEEE J. Quantum Electron., 28:875, 1992
S. A. Plotkin. Competitive routing of virtual circuits in ATM networks.{\em IEEE Journal of Selected Areas in Communications, 13(6):1128-1136, 1995
A. Poustie, R. J. Manning, A. E. Kelly, and K. J. Blow: All-optical binary counter. Optics Express, 6:69-74, 2000

### SUMMARY OF INVENTION

In the present disclosure we give a description of a network, together with the associated network-protocol, in which

The n Senders and the r Receivers are connected with only r^{o(1)} channels (Here o(1) denotes a quantity which goes to 0 as r goes to the infinity.) Note, that in practice at most 32 channels are enough. The parallel channels will not speed up the transmission relative to the 1-channel network: the goal of using them is to facilitate the privacy of the communication and the distribution of the messages between the recipients, without any encryption or routers.

The encoding and decoding is nothing else just linear combinations of the message-bits, and this linear combinations can be computed really fast.

There are no switching or routing-elements in the network with hard-to implement buffers and local memory, just linear combinations are computed, with fixed connections (channels or wires); moreover, the network components used are simple enough to implement in fast all-optical networks.

Rₚ₍ᵢ₎ can learn only very little about any bit of the message of Sⱼ for any p(j) not equal to p(i), and only a negligible amount of information on longer messages of Sⱼ.

The security of our network is information-theoretical rather than cryptographical, in the sense that it does not depend on unproven cryptographical primitives.

In packet-switched networks, the Receivers should know their own identity (say, an IP or MAC address) in order to pick up only those packets from the transmission channels, which are addressed to them. In the disclosed network architecture, the Receivers need not know even their own identity: the bits, intended to be sent to them, will find them securely and automatically.

### BRIEF DESCRIPTION OF DRAWINGS

FIG. 1 is a schematic drawing of our network in the case when the number of the Senders and the Recievers are also n.

FIG. 2 is a drawing of a preferred embodiment of the invention as a multicasting network.

### DETAILED DESCRIPTION

Let S₁, S₁, . . . , Sₙ denote the Senders, and let R₁,R₂, . . . , Rᵣ denote the Receivers.

Additionally, we have t<n data transmission channels, used for long-distance connection between Senders and Receivers. Each Sender is connected through some modular addition gates to all of these t channels, while the Receivers may be connected through modular addition gates only to certain subsets of the channels.

On one channel one bit may be transmitted at a time. If one Sender sends several bits simultaneously to an h element subset of the t long-distance channels, then these bits will travel synchronously on these h channels: that means, that for any i, Receiver Rᵢ will get those bits which were sent simultaneously, from all the long-distance channels, connected to Rᵢ, at the same time. However, we do not suppose that different Receivers get these bits at the same time (it is allowed that farther situated Receivers get the bits later than the closer ones).

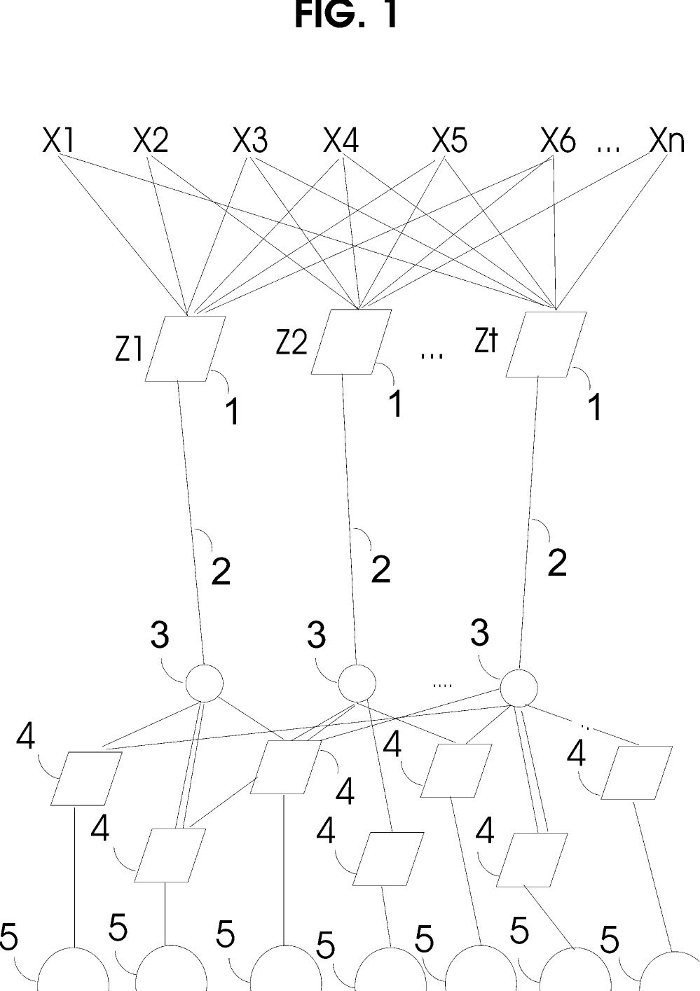

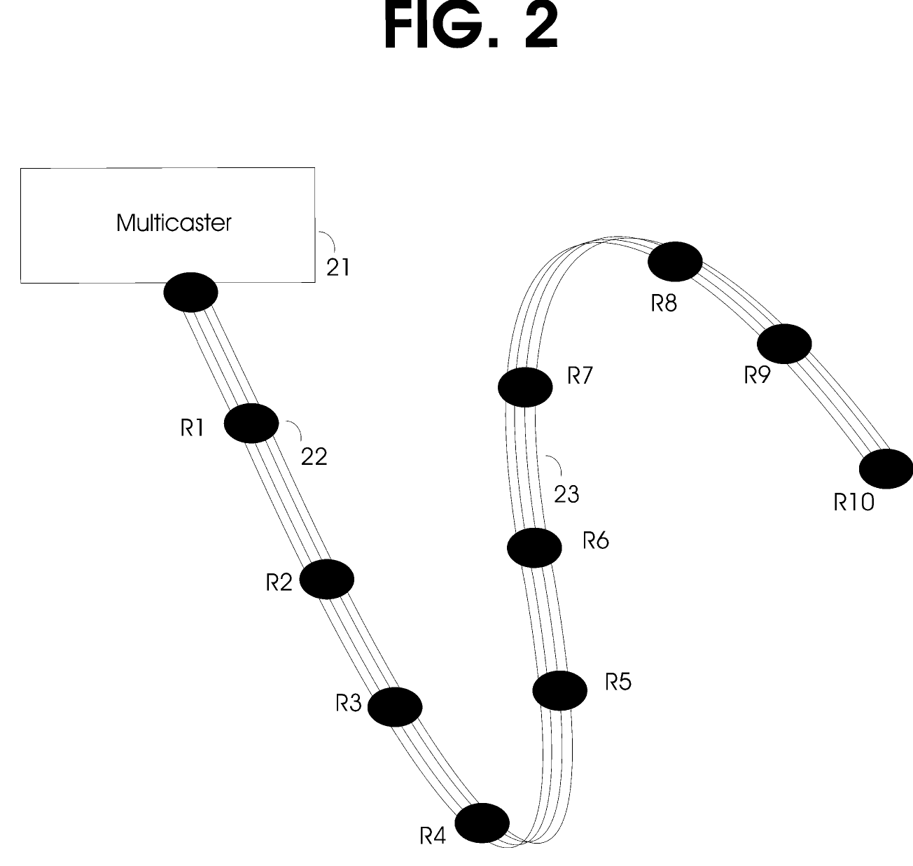

FIG. 1 describes the general scheme in the case when n=r. We need that the Sender's bits travel synchronously on the t long-distance channels (item 2). (Note, that this requirement can be assured by using the same wavelength optical signals on each channel, and by compensating for the distance-differences at the Senders side by installing fiber loops: this way the signals—if sent simultaneously by all the senders—will travel synchronously). However, we need not assume that the signals reach all the Receivers at the same time: the Receivers are allowed to be scattered along the long-distance channels (see FIG. 2).

A general method was shown in (Vince Grolmusz: Low Rank Co-Diagonal Matrices and Ramsey Graphs, Electronic Journal of Combinatorics, Vol. 7, (2000), No. 1, R15) for the construction of n×n matrices A′ with 0's in the diagonal and non-zeroes elsewhere modulo a non-prime power integer, denoted by m. Said construction has the main property that said matrices have small rank modulo m, that is, matrix A′ can be written as the matrix product B′C′ modulo m, where B′ is an n×(t−1) and C′ is a (t−1)×n matrix with integer elements, where t is a small number relative to n, that is, t=n^{o(1)}, where o(1) denotes a positive quantity which goes to 0 as n goes to the infinity.

It is also known from the prior art, that said matrix A′ can be constructed that way, that if m has distinct prime divisors p₁, p₂, . . . , pᵣ, then the non-zero elements of matrix A′ are either 0 or 1 modulo pᵢ, for i=1,2, . . . , r. For example, if m=6, then the non-zero elements of matrix A′ are either 3 or 4, modulo 6.

Let J denote the n×n all−1 matrix. Let us consider the matrix A=J−A′. It contains 1's in the diagonal, and numbers, congruent to zero modulo at least one prime divisor of m. Returning to the previous example, with m=6, we have that A has either 3 or 4 or 0 outside of the diagonal.

Matrix A can be written as the matrix product BC modulo m, where B is an n×t and C is a t×n matrix with integer elements.

There are several other ways to construct matrices with similarly useful properties than that of A. Such method is known from the prior art (e.g., Vince Grolmusz: A Note on Explicit Ramsey Graphs and Modular Sieves, Combinatorics, Probability and Computing Vol. 12, (2003) pp. 565-569). Another way is to construct matrix A is as follows: the entry in row i and column j of matrix A is defined as the Hamming-distance of the binary forms of numbers i and j. By this definition we get matrices B and C such that A=BC, where B is an n×t and C is a t×n matrix with integer elements, and t=O(log n).

The larger the quantity n is, the smaller the quantity t becomes, relative to n.

Let x=(x₁, x₂, . . . ,xₙ) be a sequence of n variables. We can compute the following t=n^{o(1)} linear forms of the xᵢ's, denoted by z=(z₁, z₂, . . . ,zₜ), such that using another linear transform to this z, we get back a representation of the x. More exactly, Let A=BC. Then let z=xB, and x′=zC=xBC=xA. This forms the main idea of our network architecture.

First we describe the network in the case when n=r and Sender Sᵢ wants to send bit xᵢto Receiver Rᵢ, for i=1,2, . . . , n.

FIG. 1 gives a schematic description of the network. From bits x=(x₁,x₂, . . . , xₙ), numbers z=(z₁,z₂, . . . ,zₜ)=xB are computed with the modular addition gates (item 1). Numbers z₁,z₂, . . . , zₜ are transmitted on the t long-distance channels (item 2). At the receivers' side (item 3), from these z₁z₂, . . . , zₜ numbers, modular gates (item 4) compute the n coordinates of x′=xBC=xA.

Note, that generally x′ is not equal to x; for example, if m=6, then matrices B and C can be chosen such that x′=x+4xU+3xV=xBC=zC=xA, where U and V are n×n matrices with 0′ in the diagonal, satisfying that at any non-diagonal position either U or V is zero modulo 6.

Consequently, for the retrieval of the original message bits x, some further steps should be taken. We disclose a method, called filtering here.

We describe the transmission-protocol and the filtering method in rounds. In every round, every sender Sᵢ will transmit securely a bit xᵢ to the corresponding receiver, Rᵢ, i=1,2, . . . , r. In u consecutive rounds, every sender will send u bits, that is, sending u-bit messages needs u rounds of the following protocol.

A round is performed as follows:
Step 1—Encoding (item 1)—From the bits of x the mod m integers z=(z₁,z₂, . . . ,zₜ) are computed by linear combinations taken modulo m: z=xB mod m.
Step 2 (item 2)—Transmission—The mod m numbers z₁,z₂, . . . , zₜ are sent on t channels to the receivers.
Step 3—Decoding—The linear transformation x′=(x′₁,x′₂, . . . ,x′ₙ, =xBC=xA=zC is computed modulo m at the receivers' side, and number x′ᵢ is given to receiver Rᵢ, for i=1,2, . . . ,r. (Note, that because of information-theoretical reasons, generally it is not possible to retrieve bit xᵢ from integer x′ᵢ).
Step 4—Pre-Filtering—A random g permutation on the set {1,2, . . . , n} is generated at the sender's side. Then for j=1,2, . . . ,n, steps 1, 2 and 3 are repeated for x^{g(j)} instead of x, where x^{g(j)} coincides with x, except on position g(j), whereas x^{g(j)} is 0 if it was 1 in x, or 1 if it was 0 in x. Let x″ⱼ denote the coordinate i of x^{g(j)}CT.
Step 5—Post-Filtering—Now, receiver Rᵢ stores value x′ᵢ in its memory, and follows the next program after receiving any new x″ᵢ, originating in Step 4:
   if x″ᵢ−x′ᵢ is divisible by a prime divisor of number m, it does nothing;
   if x″ᵢ=x′ᵢ−1 modulo m, then Rᵢ concludes that xᵢ=1;
   if x″ᵢ=x′ᵢ+1 modulo m, then Rᵢ concludes that xᵢ=0.

Next we disclose our network protocol in the case n=r and Sender Sᵢ intends to send messages to Receiver Rₚ₍ᵢ₎ where p(i) is a permutation. The network can easily be reconfigured as follows. Since all the Senders are connected to all the channels—Sender Sᵢ will simply send the same messages as Sender Sₚ₍ᵢ₎ would have sent to Rₚ₍ᵢ₎. Note, that no wiring and no modular addition gates (items 1 and 4 on FIG. 1) are changed.

Next we disclose the network protocol in the case when n and r are not necessarily equal, and the function p from {1,2, . . . ,n} to {1,2, . . . , r} gives the addresses of the messages: Sender Sᵢ wants to send message to Receiver Rₚ₍ᵢ₎, for i=1,2, . . . ,n.

If p(i) is an injection (that is, no Receiver gets messages from two different Senders), then the original network protocol (and filtering) works.

Suppose now, that S₁, S₂, S₃ want to send messages to—say—R₁. Then we play the original network protocol with the substitution x₁+x₂+x₃ for x₁ and 0 for x₂ and x₃. Then, x₁+x₂+x₃ will appear at R₁ with coefficient 1. Now, in the filtering process, only those random permutations may be used that fix the order of the image of the first three numbers, for example, for the images of x₁x₂x₃, the image of ,x₁, should precede the image of x₂, and this should precede the image of x₃ and , This property facilitates that R₁ can recollect the bits of the long sequences which is sent to her by S₁, S₂ and S₃, respectively. Clearly, this method can be generalized to any other function p, by fixing the order of the images of variables sent to the same Receivers.

The privacy in the messaging of the network-protocol relies on the independently generated random permutations g in each round. Let us review, what Rᵢ can learn from the bits, addressed to others. After each round of the protocol, Receiver Rᵢ learns its own bit, and also the number of the 1-bits with the same, not-1 coefficients in the form of x′₁, for i=1,2, . . . ,n, but Rᵢ will not know the identity of that bits.

Although the subject invention has been described with respect to particular embodiments, it will be readily apparent to those having ordinary skill in the art to which it pertains that changes and modifications may be made thereto without departing from the spirit or scope of the subject invention as defined by the appended claims.

1. A method for dense and secure transmission of signals and information using a small number of channels, the method comprising
a) choosing an appropriate integer modulus m, positive integer n, corresponding to the number of bits to be encoding, and generating n x n matrix A with integer elements where the diagonal elements of A differs modulo m from all the other elements of their column, and where A can be written as matrix product BC where B is an n×t matrix, C is a t×n matrix, where t is less than n;
(b) encoding the length-n vector x to the length-t vector xB, by vector-matrix product modulo m;
(c) transmitting the coordinates of the length-t vector xB on t channels;
(d) retrieving the coordinates of the vector by computing xBC=xA by vector-matrix product modulo m;
(e) for every coordinate of vector xBC=xA, filtering out the terms added as the linear combination of other coordinates of vector x:

2. A method according to claim 1, wherein the modulus m is non-prime-power composite positive integer, the diagonal elements of matrix A are non-zero modulo any prime-divisors of m, and each non-diagonal elements of matrix A are zero modulo for at least one prime divisor of m.

3. A method according to claim 2, wherein the filtering step for retrieving the original values of the transmitted 0-1 vector further comprising:
(a) periodical change of the values of the coordinates of vector x with original value equal to 1 on values 0,1,2, . . . , m−1 in this order, and on values of m−1,m−2, . . . ,3,2,1,0 in this order of the coordinates of vector x with original value equal to 0;
(b) measuring the periodicity of each coordinates of vector xBC=xA;
(c) if a coordinate has period less than m then it is be neglected;
(d) if a coordinate has period equal to m, and it changes its values as 0,1,2, . . . ,m−1, then its original value was 1;
(e) if a coordinate has a period equal to m, and it changes its values as m−1,m−2, . . . , 3,2,1,0, then its original value was 0.

4. A method, according to claim 3, wherein the periodic change of the discrete values of the coordinates of vector x are approximated by continuous wave forms of electronic, magnetic or optical signals.

5. A method, according to claim 1, wherein between the communicating nodes R₁, R₂, . . . ,Rₙ and S₁, S₂, . . . , Sₙ two networks are constructed, in the first network nodes S₁, S₂, . . . , Sₙ play the role of the senders and R₁, R₂, . . . , Rₙ play the role of the receivers, and in the second network R₁, R₂, . . . , Rₙ play the role of the senders and S₁, S₂, . . . , Sₙ play the role of the receivers.

6. A method, according to claim 1, wherein the filtering step for retrieving the original values of the transmitted 0-1 vector further comprising:
(a) change of the values of the coordinates of vector x with original value equal to 1 to value 0, and the coordinates of vector x with original value equal to 0 to 1;
(b) measuring the change of each coordinates of vector xBC=xA;
(c) if the change in the value of in coordinate i (where integer i is between 1 and n) is not the ith diagonal element of matrix A modulo m or not (−1)-times the ith diagonal element of matrix A modulo m, then the change is neglected;
(d) if the change in the value in coordinate i (where integer i is between 1 and n) is the ith diagonal element of matrix A modulo m then original value was 0;
(e) if the change in the value in coordinate i (where integer i is between 1 and n) is (−1)-times the ith diagonal element of matrix A modulo m then original value was 1.
